(19) United States
(12) Patent Application Publication
(10) Pub. No.: US 2005/0264704 A1
(43) Pub. Date: Dec. 1, 2005

(54) Media device and method of enhancing viewing of video information in media device

(76) Inventor: Marko E. Leinonen, Oulu (FI)

Correspondence Address: Hollingsworth & Funk, LLC, Suite 125, 8009 34th Avenue South, Minneapolis, MN, 55425, US

(21) Appl. No.: 10/855,133

(22) Filed: May 27, 2004

(51) Int. Cl. H04N 5/38; G06K 7/14

(52) U.S. Cl. 348/723; 348/469

(57) ABSTRACT

A method of enhancing the viewing of information in digital video format in a media device is provided. Digital video information is read from a memory and converted with a controller into a television signal. The television signal is low pass filtered with a filtering unit in a wireless communication unit of the media device. A wireless communication signal is generated with an oscillator in the wireless communication unit and the signal is divided in a divider with a predefined factor to obtain an RF frequency signal which is further multiplied with a multiplier in the wireless communication unit by the television signal, thus obtaining a multiplied television signal in an RF output connector in the wireless communication unit of the media device.

### FIELD

The invention relates to media devices configured to store information in video format, such as movies, and a method of enhancing the viewing of the movies.

### BACKGROUND

Modern terminal equipment offers users many services in addition to being conventional phones. The equipment can be used as a versatile media device for viewing multimedia presentations, multimedia messages, audio and video information, such as music and movies. The same also applies to personal computers and portable personal digital assistants (PDA). The memory capacity of these devices has increased and is expected to increase even more in the near future. Users may load various digital media to the devices and access the media later. For example, it will be possible to load movies in DVD (Digital Versatile Disk) format into the media devices for future viewing.

One problem associated with these media devices is that the display of the devices is typically small. The small size is due to the portability of the devices. Typical terminal equipment and PDAs are intended to be handheld devices and their size is usually smaller than the size of a conventional shirt pocket. The small display makes viewing movies less enjoyable as users are used to view movies from a large TV screen. A typical diagonal size for a TV screen may be from 14″ to 60″ whereas the typical size of a media terminal is 3.5″.

In many situations a user of a media device may be in a place where a television set is available. The user may be in a hotel room equipped with a television set, for example. It would be advantageous if the television set could be used for viewing movies stored in a media device. However, currently media devices do not have a coaxial television signal output. Media devices, such as terminal equipment, PDAs or laptop personal computers, are usually equipped with a short range wireless connection, such as Wireless Local Area Network (WLAN) connection, or a Low power radio frequency (LPRF) connections, such as Bluetooth. These connections offer short range radio based communications with relatively low power consumption. Designing a specific television output, such as a SCART connector output, for these media devices would increase the cost and the size of the devices.

### BRIEF DESCRIPTION OF THE INVENTION

An object of the invention is to provide an improved solution for enhancing viewing of information in digital video format. According to an aspect of the invention, there is provided a media device, comprising: a memory to store information in a digital video format; a controller operationally connected to the memory; a wireless communication unit operationally connected to the controller; the controller being configured to read digital video information from the memory, and convert the digital video information into a television signal; the wireless communication unit comprising a filtering unit to low pass filter the television signal; an oscillator to generate a wireless communication signal; a divider to divide the wireless communication signal with a predefined factor to obtain an RF frequency signal, a multiplier to multiply the television signal with the RF frequency signal; and an RF output connector to output the multiplied television signal.

According to another aspect of the invention, there is provided a method of enhancing the viewing of information in digital video format in a media device, the method comprising: storing information in a digital video format in a memory; reading digital video information from the memory; converting the digital video information into a television signal with a controller; low pass filtering the television signal with a filtering unit in a wireless communication unit of the media device; generating a wireless communication signal with an oscillator in the wireless communication unit; dividing the wireless communication signal with a predefined factor with a divider in the wireless communication unit to obtain an RF frequency signal; multiplying the television signal with the RF frequency signal by a multiplier in the wireless communication unit, thus obtaining a multiplied television signal in an RF output connector in the wireless communication unit of the media device.

The invention provides several advantages. In an embodiment of the invention, an existing wireless connection transceiver of the media device is utilized in realizing video output in television format. This enables the user of the device to watch movies stored in the media device using a nearby television set. The realization of the device of this embodiment does not increase the size of the device, as the number of new required components is small.

In an embodiment of the invention, the television output is realized utilizing a WLAN transmitter unit of the media device. In another embodiment of the invention, the television output is realized utilizing a Bluetooth transmitter unit of the media device. In both of these embodiments, no extra radio frequency module is needed in the media device. By making small modifications to the WLAN or Bluetooth units and equipping the device with an additional connector it is possible to connect a television set to the media device and view movies stored in the device from the television, for example.

The connection between the media device and a television may be realized with a coaxial antenna cable or with a wireless connection.

### LIST OF DRAWINGS

In the following, the invention will be described in greater detail with reference to the embodiments and the accompanying drawings, in which

FIGS. 1A to 1C illustrate embodiments of the invention;

FIG. 2 illustrates an example of a media device;

FIG. 3 illustrates an embodiment of the invention with a flowchart;

FIG. 4 illustrates another example of a media device;

FIG. 5 illustrates VSB modulation;

FIGS. 6A and 6B illustrate embodiments of transmitter sections of a transceiver unit,

FIGS. 7 and 8 illustrate yet other embodiments of a transmitter section of a transceiver unit.

### DESCRIPTION OF EMBODIMENTS

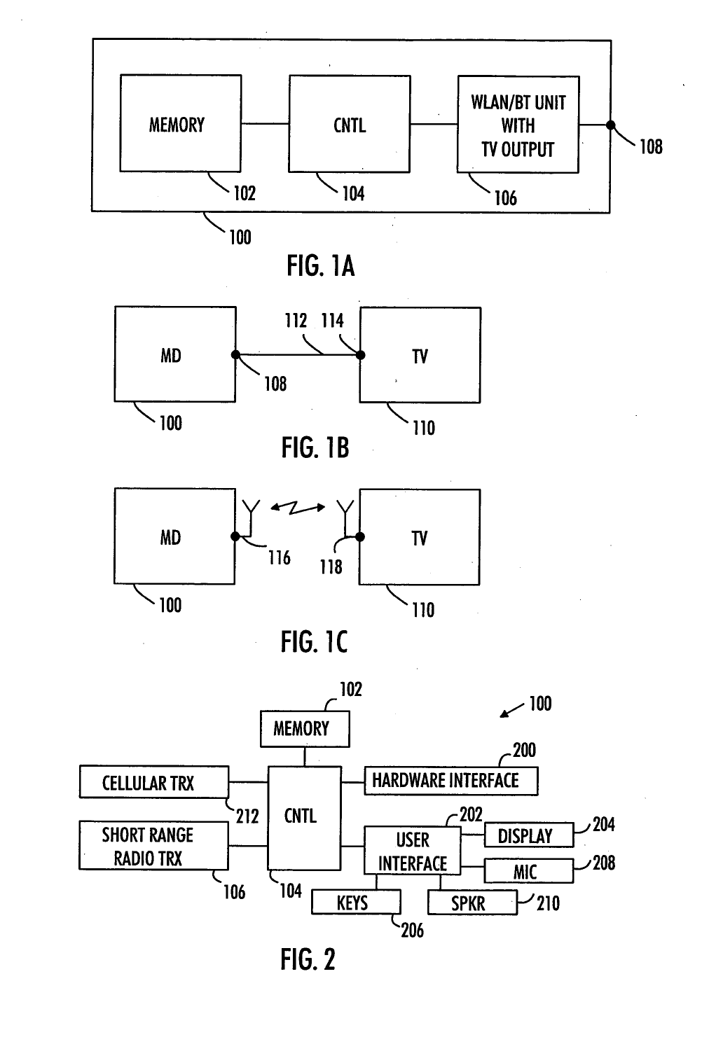

With reference to FIG. 1A, examine an example of a device of an embodiment of the invention. The media device 100 comprises a memory unit 102, which is configured to store video in digital format. One such format may be MPEG4 format used in DVDs. The memory unit may be realized with a hard disk, memory chips, a card reader, an external USB (Universal Serial Bus) memory device or another corresponding device. The device further comprises a controller 104 configured to control the operation of the device. In an embodiment, the controller is configured to read video information from the memory unit and convert the information from MPEG4 format to a format suitable for an analog television. Formats supported by an analog television include PAL, NTSC and SECAM, for example. These formats and the required conversions are well known to one skilled in the art. The control processor forwards the converted signal to a wireless transceiver unit 106, which is in this example a WLAN or a Bluetooth transceiver with a television transmitter. The control processor controls the wireless transceiver unit to process the converted signal further so that the signal is suitable for a television set. In the wireless transceiver unit 106, the signal is filtered and modulated into a suitable television channel. The processed signal is taken to a coaxial connector 108.

FIG. 1B illustrates an embodiment where the media device 100 is connected to a television set 110 with a coaxial cable 112. The coaxial cable is connected to the coaxial connector 108 of the media device 100 and to an RF input 114 of the television set 110. The television set 110 sees the media device 100 as a normal VCR (Video Cassette Recorder).

FIG. 1C illustrates an embodiment where an antenna 116 is connected to the coaxial connector 108 of the media device 100. In this embodiment, the media device transmits the signal wirelessly into the antenna 118 of the television set 110.

FIG. 2 illustrates a more detailed example of the media device 100. The media device 100 comprises a controller 104 configured to control the operation of the device. The controller is typically implemented with one or more general or signal processors and suitable software. The controller may also be implemented with discrete components such as ASICs (Application Specific Integrated Circuits), for example.

The media device 100 may comprise a hardware interface 200 connected to the controller 104. The hardware interface provides the media device with an interface to outside systems. The interface may be implemented with a USB port, Firewire port, USB memory reader or any other interface type suitable for transferring data between electronic devices.

The media device 100 comprises a memory unit 102 which is configured to store video in digital formats. The suitable information source may be connected to the hardware interface 200 of the media device. The control processor may read information from the source and store it in the memory. As stated in connection with FIG. 1, the memory unit may be realized with a hard disk, one or more internal memory chips, a card reader such as a MultiMediaCard (MMC) reader, a USB (Universal Serial Bus) memory or another corresponding device.

The media device 100 comprises a user interface 202 with which the user of the device interacts with the device. The user interface 202 may comprise different components. Typically, the user interface includes a display 204, a keyboard 206, a microphone 208 and a speaker 210. The display 204 may be a color or a black and white display. The keyboard 206 may be a QWERTY keyboard as in personal computers, a phone type numeric keyboard, a separate keyboard or a keyboard integrated with the display as a touch sensitive display.

The media device 100 may further comprise a cellular transceiver unit 212. The unit may be a GSM or a WCDMA transceiver unit, for example. The cellular transceiver unit 212 enables the media device to act as a mobile phone.

In addition, the media device 100 further comprises a short range wireless transceiver unit 106. Examples of such units are Wireless Local Area Network (WLAN) transceiver or a low power radio frequency (LPRF) transceiver, such as a Bluetooth transceiver.

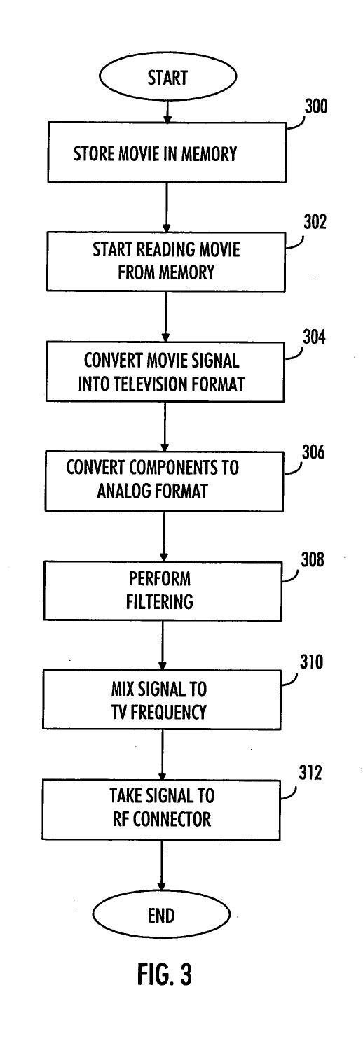

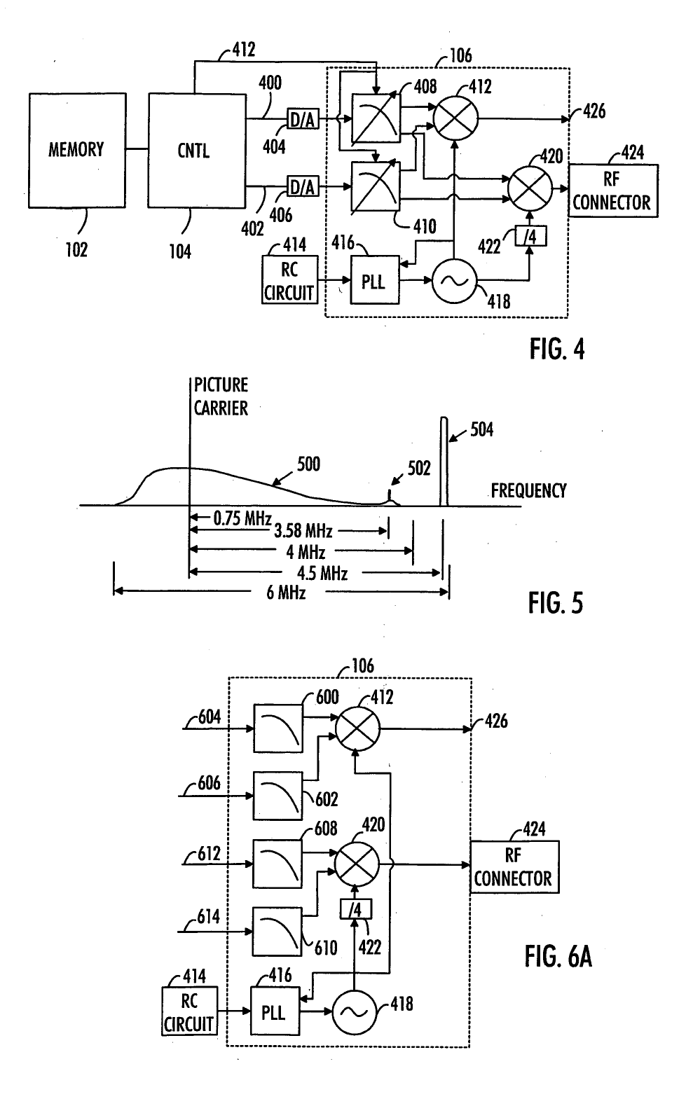

With reference to FIGS. 2 to 5, study an example of an embodiment of the invention. FIG. 3 shows a flowchart illustrating an embodiment of the invention. FIG. 4 illustrates an example of a section of the media device. The example of FIG. 4 shows the memory 102, the controller 104 and the transmitter section 106 of a WLAN 802.11b transceiver unit.

In step 300, a movie in an MPEG4 format is stored in the memory 102 of a media device. At a later stage, the user of a media device may wish to view the movie stored in the memory 102 of the user's media device and utilize an external television set as a display for the media device. After receiving a command from the user, the controller 104 of the media device starts reading the movie file from the memory in step 302.

In step 302, the controller 100 converts the digital video information of the movie file into a television signal. In an analog PAL television system, the signal is modulated using vestigial sideband modulation (VSB). FIG. 5 illustrates VSB modulation. The signal comprises the luminance component of the video signal 500, color information 502 and audio 504 as a separate component. The coding of color information depends upon the system used. There exist three main methods, PAL, NTSC, SECAM (Phase Alternating Line, National Television Standards Committee, Sequentiel Couleur avec Mémoire). The conversion of a MPEG4 to a television signal can be performed according to the methods known to one skilled in the art. After the conversion two signals 400, 402 are at the output of the controller 104. The signals are I- and Q-components of the television signal, if quadrature modulation is used in transmitter section 106.

In step 306, the components are converted into an analogue form in converters 404, 406.

In step 308, the analogue components are taken to the wireless transceiver unit 106 and to low pass filters 408, 410. The low pass filters 408, 410 may be adjustable. The controller 104 provides a control signal 412 which selects the filter characteristics to be used. When the input signals 400, 402 of the wireless transceiver unit 106 are to be transmitted using the wireless system supported by the unit, such as WLAN, the control signal 412 directs the low pass filter to use a corner frequency which is suitable for a WLAN signal having a 22-MHz bandwidth. When the input signals 400, 402 of the wireless transceiver unit 106 are to be transmitted as a television signal using an RF connector, the control signal 412 directs the low pass filter to use a corner frequency suitable for a television signal having a 8 MHz bandwidth.

When the input signals 400, 402 of the wireless transceiver unit 106 are to be transmitted using the wireless system supported by the unit, such as WLAN, the filtered signals are taken into a mixer 412, where the signals are mixed into a suitable WLAN frequency. In WLAN, the center frequencies are between 2412 to 2472 MHz with step of 5 MHz.

In an embodiment, the media device comprises an RF circuit 414 generating a reference frequency of 1 MHz. The reference frequency is taken into a phase locked loop 416, which controls a voltage controlled oscillator 418. In an embodiment, the tuning range of the oscillator is from 2412 to 2472 MHz. In another embodiment, the tuning range of the oscillator is from 2365 to 2493 MHz. The tuning is controlled on the basis of the desired WLAN frequency. The WLAN output signal of the oscillator 418 is taken to the mixer 412. The output signal of the mixer 412 is taken to a wireless output 426, where the signal is transmitted.

In step 310, the filtered signals are taken into a mixer 420 where the signals are mixed into an RF frequency suitable for television. Table 1 illustrates an example of the relationship between TV channels and carrier center frequencies.

TABLE 1

| Channel Number | MHz | *4 |
|---|---|---|
| 36 | 591.25 | 2365 |
| 37 | 599.25 | 2397 |
| 38 | 607.25 | 2429 |
| 39 | 615.25 | 2461 |
| 40 | 623.25 | 2493 |

The filtered signals are mixed in the mixer 420 with a signal originating from the oscillator 418. The output signal of the oscillator 418 is first supplied to a divider 422 where signal is divided by four. The result of the division is supplied to the mixer 420.

In Table 1, the first column shows TV channels numbers and the second column the corresponding frequencies. The third column shows the frequency value when the TV channel frequency is multiplied by four.

Thus, in the embodiment where the tuning range of the oscillator is from 2412 to 2472 MHz, TV channels 38 and 39 can be obtained.

In another embodiment where the tuning range of the oscillator is from 2365 to 2493, TV channels 36 to 40 can be obtained.

In an embodiment, the media device comprises an RF circuit 414 generating a reference frequency of 5 MHz. In such a case TV channel 37 can be obtained in mixer 420.

In step 312, the mixed TV signal is taken to an RF connector 424. The signal may be delivered to a television set using a coaxial cable connected to the RF connector.

The media device may also comprise other components, such as switches, filters and amplifiers, as one skilled in the art is aware.

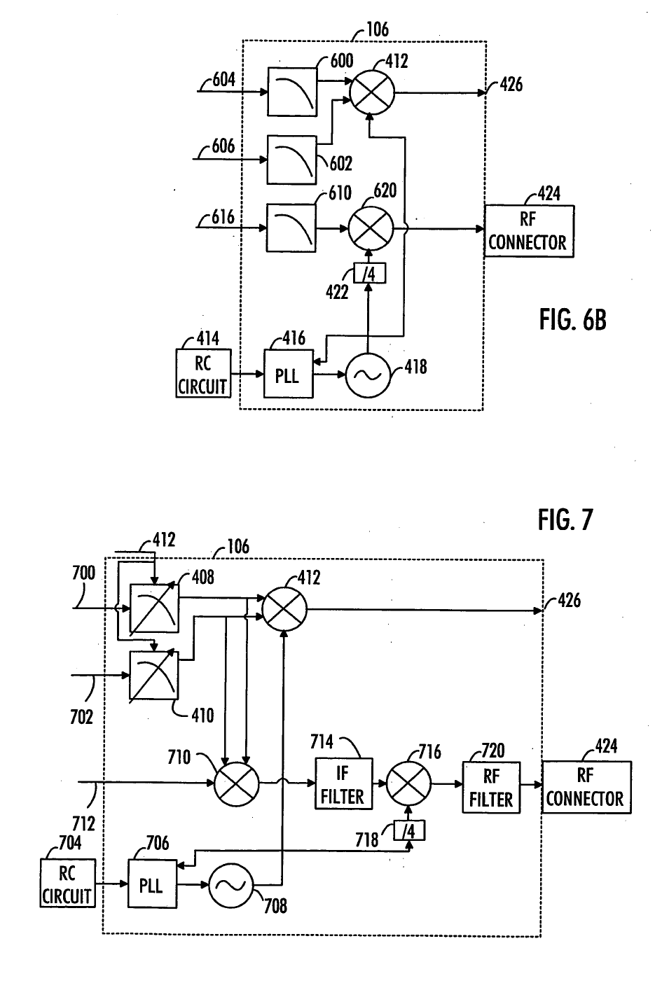

FIG. 6A illustrates an embodiment where the wireless transceiver unit 106 comprises low pass filters 600, 602 to the I and Q components of WLAN signals 604, 606 and low pass filters 608, 610 to the I and Q components 612, 614 of television signals. Thus, the low pass filters do not need to be adjustable. Otherwise, the embodiment is similar to the embodiment of FIG. 4.

FIG. 6B illustrates an embodiment where television signal is not divided into I and Q components. Thus, the wireless transceiver unit 106 comprises a low pass filter 618 for the television signal 616. From the filter 618, the filtered signal is taken to mixer 620, where the signal is mixed as in the previous examples.

FIG. 6A may also be used to illustrate an embodiment where wireless transceiver unit 106 supports Bluetooth transmission. In this embodiment, the signals 604, 606 coming from the controller 104 are Bluetooth signals. The low pass filters 600, 602 have a corner frequency which is suitable for a Bluetooth signal having a 1-MHz bandwidth. Otherwise, the operation of the embodiment is similar to the above examples.

FIG. 7 illustrates an embodiment where intermediate frequency (IF) is utilized. Only the transmitter section of the wireless transceiver unit is shown. This embodiment provides better overall filtering with the cost of a slightly more complicated design.

The input signals 700, 702 to the wireless transceiver unit 106 are the digitized I and Q components from the controller 104. The components are taken to low pass filters 408, 410. The low pass filters 408, 410 may be adjustable. The controller 104 provides a control signal 412 which selects the filter characteristics to be used. When the input signals 400, 402 of the wireless transceiver unit 106 are to be transmitted using WLAN, the control signal 412 directs the low pass filter to use a corner frequency which is suitable for a WLAN signal. When the input signals 700, 702 of the wireless transceiver unit 106 are to be transmitted as a television signal using RF connector, the control signal 412 directs the low pass filter to use a corner frequency suitable for a television signal.

When the input signals 700, 702 of the wireless transceiver unit 106 are to be transmitted using WLAN, the filtered signals are taken into a mixer 412 where the signals are mixed into a suitable WLAN frequency.

The media device comprises an RF circuit 704 generating a reference frequency of 0.2 MHz. The reference frequency is taken into a phase locked loop 706, which controls a voltage controlled oscillator 708. In this embodiment, the tuning range of the oscillator is from 2211.4 to 2472 MHz. The tuning is controlled on the basis of the desired WLAN frequency. The output signal of the oscillator 708 is taken to the mixer 412. The output signal of the mixer 412 is taken to a wireless output 426, where the signal is transmitted.

When the input signals 700, 702 of the wireless transceiver unit 106 are TV signals the signals are taken into a mixer 710 where the signals are mixed into an RF frequency suitable for television. The filtered signals are mixed in the mixer 710 with an IF signal, which is a sinusoidal local injection signal 712. IF frequency is selected so that it matches the used VCO tuning range The output signal of the mixer 710 is filtered in the IF filter 714. The filtered signal is taken further to a mixer 716, where the signal is mixed with a signal obtained from the oscillator 708 via the divider 718 where the oscillator output signal is divided by four.

The output signal of the mixer 716 is taken to an RF filter 720 and to the RF connector 424. In this embodiment, TV channels 36 to 40 can be obtained.

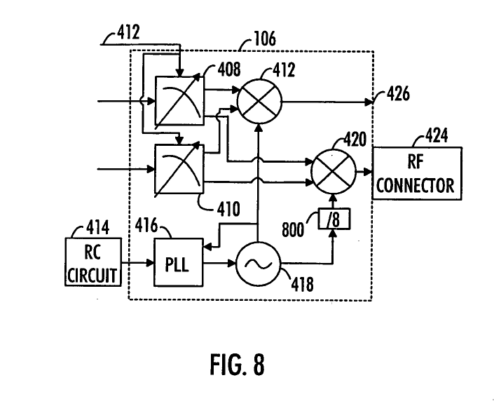

FIG. 8 illustrates an embodiment where transmitter section 106 of a WLAN 802.11a transceiver unit is utilized. In the embodiment of FIG. 4, a WLAN 802.11b was utilized. The frequency area of 802.11a is 5.150 to 5.727 GHz. In WLAN 802.11b, the frequency is about half of 802.11a, or 2.400 to 2.483 GHz. Thus, in the example of FIG. 8, the output signal of the oscillator 418 is about twice the frequency of FIG. 4. The output signal of the oscillator 418 is taken to a divider 800, which divides the oscillator signal by eight instead of four as in FIG. 4. Thus the television signal can be mixed to correct frequencies. In this embodiment, TV channels that can be obtained are related to the selected VCO tuning range. The channels, which are directly supported with 802.11 a European frequency band, are TV channel numbers from 43 to 51.

The above described embodiments analog television transmission. However, the invention can be used also in connection with digital television transmission. FIGS. 3 and 4 may also be used to illustrate en embodiment where digital television transmission is utilized. The FIGS. 3 and 4 have been described above and the description applies also in this embodiment with the exception of step 304 of FIG. 3, where the incoming video format is converted to a corresponding digital television format, which is defined in the selected digital television standard. The conversion is performed in the controller 104 of FIG. 4. In the DVB-T standard, the video signal is packed with a MPEG4 coding. The actual analog television transmission of the DVB (Digital Video Broadcast) signal is based on OFDMA modulation. There are several methods defined in DVB standards that support terrestrial transmission standard T, cable television transmission standard C, satellite television standard S and handheld device standard H. The OFDMA modulation is multicarrier modulation, where one television channel is constructed with several subcarriers. The required OFDMA modulation is performed in step 304. The method to generate OFDMA modulation is known to one skilled in the art.

Even though the invention is described above with reference to an example according to the accompanying drawings, it is clear that the invention is not restricted thereto but it can be modified in several ways within the scope of the appended claims.

1. A media device, comprising:
a memory to store information in a digital video format;
a controller operationally connected to the memory a wireless communication unit operationally connected to the controller;
the controller being configured to read digital video information from the memory, and convert the digital video information into a television signal;
the wireless communication unit comprising
a filtering unit to low pass filter the television signal;
an oscillator to generate a wireless communication signal;
a divider to divide the wireless communication signal with a predefined factor to obtain an RF frequency signal,
a multiplier to multiply the television signal with the RF frequency signal; and
an RF output connector to output the multiplied television signal.

2. The media device of claim 1, wherein the controller is configured to convert the digital video information to an analog television signal in PAL, NTSC or SECAM format.

3. The media device of claim 1, wherein the controller is configured to convert the digital video information to a digital television signal in DVB-T or DVB-C format.

4. The media device of claim 1, wherein the wireless communication unit further comprises a Wireless Local Area Network transceiver.

5. The media device of claim 1, wherein the wireless communication unit further comprises a Bluetooth transceiver.

6. The media device of claim 1, wherein the wireless communication unit further comprises a wireless transmitter to transmit a television signal.

7. The media device of claim 1, wherein the RF output connector is configured to be attached to a coaxial cable to output a television signal to a television set.

8. The media device of claim 1, wherein the memory means is configured to store information in MPEG format.

9. The media device of claim 4, wherein the wireless communication unit comprises common filtering unit for a WLAN signal and the television signal.

10. The media device of claim 9, wherein the common filtering unit is configured to perform filtering with different parameters on the WLAN signal and on the television signal.

11. The media device of claim 4, wherein the wireless communication unit comprises separate filtering units for a WLAN signal and the television signal.

12. The media device of claim 4, wherein the oscillator has a tuning range of 2365 to 2493 MHz.

13. The media device of claim 5, wherein the wireless communication unit comprises separate filtering units for a Bluetooth signal and the television signal.

14. The media device of claim 5, wherein the wireless communication unit comprises common filtering unit for a Bluetooth signal and the television signal.

15. The media device of claim 14, wherein the common filtering unit is configured to perform filtering with different parameters on the Bluetooth signal and on the television signal.

16. The media device of claim 1, further comprising an input port to load information in digital format to the memory.

17. A method of enhancing the viewing of information in digital video format in a media device, the method comprising:
storing information in a digital video format in a memory;
reading digital video information from the memory;
converting the digital video information into a television signal with a controller;
low pass filtering the television signal with a filtering unit in a wireless communication unit of the media device;
generating a wireless communication signal with an oscillator in the wireless communication unit;
dividing the wireless communication signal with a predefined factor with a divider in the wireless communication unit to obtain an RF frequency signal;
multiplying the television signal with the RF frequency signal by a multiplier in the wireless communication unit, thus obtaining a multiplied television signal in an RF output connector in the wireless communication unit of the media device.

18. The method of claim 17, further comprising: converting the digital video information to a PAL, NTSC or SECAM format.

19. The method of claim 17, further comprising: converting the digital video information to a digital television format.

20. The method of claim 17, wherein the wireless communication unit comprises a Wireless Local Area Network transceiver.

21. The method of claim 17, wherein the wireless communication unit comprises a Bluetooth transceiver.

22. The method of claim 17, further comprising transmitting a television signal to a television set via a coaxial cable connected to the RF output connector.

23. The method of claim 17, further comprising transmitting a television signal to a television set wirelessly via an antenna connected to the RF output connector.

24. A media device, comprising:
memory means to store information in a digital video format;
controlling means operationally connected to the memory wireless communication means operationally connected to the controlling means;
the controlling means being configured to read digital video information from the memory means, and convert the digital video information into a television signal;
the wireless communication means comprising
filtering means to low pass filter the television signal;
oscillating means to generate a wireless frequency signal;
dividing means to divide the wireless frequency signal with a predefined factor to obtain an RF frequency signal,
multiplying means to multiply the television signal with the RF frequency signal; and
RF output means to output the multiplied television signal.
